(19) United States
(12) Patent Application Publication
(10) Pub. No.: US 2026/0361827 A1
(43) Pub. Date: Nov. 12, 2026

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventor: Yuto SHIONO, Kanagawa (JP)

(73) Assignee: FUJIFILM Business Innovation Corp., Tokyo (JP)

(21) Appl. No.: 19/372,825

(22) Filed: Oct. 29, 2025

(30) Foreign Application Priority Data
May 8, 2025 (JP) 2025-077956

(51) Int. Cl. H04N 1/21; H04N 1/00

(52) U.S. Cl. CPC H04N 1/2166; H04N 1/00331; H04N 1/00408; H04N 1/00795; H04N 2201/0081; H04N 2201/21

(57) ABSTRACT

A substrate processing apparatus including: a chamber having an inner space for processing a substrate; and an airflow supply unit for supplying airflow to the inner space, in which the airflow supply unit includes: a normal air supply line for supplying normal air to the inner space; a dry air supply line for supplying dry air with humidity lower than humidity of the normal air to the inner space; and a first dry air supply unit connected with the dry air supply line to supply dry air, and the first dry air supply unit includes: a rotor unit containing a desiccant that removes moisture from the air; a dehumidification line that supplies air dried while passing through the rotor unit to the inner space through the dry air supply line; and a regeneration line that dries and regenerates the desiccant by heating air and making the heated air pass through the rotor unit.

### CROSS-REFERENCE TO RELATED APPLICATIONS

This application is based on and claims priority under 35 USC 119 from Japanese Patent Application No. 2025-077956 filed May 8, 2025.

### BACKGROUND

### (i) Technical Field

The present disclosure relates to an information processing system and a non-transitory computer readable medium.

### (ii) Related Art

Japanese Unexamined Patent Application Publication No. 2019-041153 discloses an information processing apparatus that stores data received by facsimile communication in a storage location corresponding to the transmission source of the data.

Japanese Unexamined Patent Application Publication No. 2023-099211 discloses an information processing apparatus that stores image data in a folder with the name of a character string obtained by character recognition processing and that reduces the effort required to prevent transmission of the image data to an unintended folder.

### SUMMARY

Aspects of non-limiting embodiments of the present disclosure relate to providing an information processing system and a program capable of determining a storage folder in which a document file of a document read by a reading device is stored from among a plurality of folders with any folder names.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: acquire information of a folder structure in a designated folder that is designated by a user; acquire a document file of a document read by a reading device and information of a character recognition result for the document file; when a folder that matches a character string included in the character recognition result for the document file is present among names of folders in a first layer of the designated folder, determine that the matching folder is a storage folder of the document file; determine a storage folder of the document file by the same processing as the first layer in layers from a second layer to a lowermost layer of the designated folder and determine a storage path indicating a storage destination of the document file; and store the document file in the storage destination indicated by the determined storage path.

### BRIEF DESCRIPTION OF THE DRAWINGS

Exemplary embodiments of the present disclosure will be described in detail based on the following figures, wherein:

FIG. 1 is a diagram illustrating a system configuration of an image reading system according to an exemplary embodiment of the present disclosure;

FIG. 2 is a block diagram illustrating a hardware configuration of an image forming apparatus in the information processing system;

FIG. 3 is a diagram illustrating an example of a document;

FIG. 4 is a diagram illustrating an example of a structure of a designated folder that is designated by a user;

FIG. 5 is a diagram illustrating an example of a document;

FIG. 6 is a diagram illustrating an example of a structure of a designated folder that is designated by a user;

FIG. 7 is a flowchart illustrating an example of a flow of processing to determine a storage folder in which a document file is stored in the image forming apparatus according to the exemplary embodiment; and

FIG. 8 is a flowchart illustrating an example of a flow of processing to determine a storage folder in which a document file is stored in the image forming apparatus according to a modification.

### DETAILED DESCRIPTION

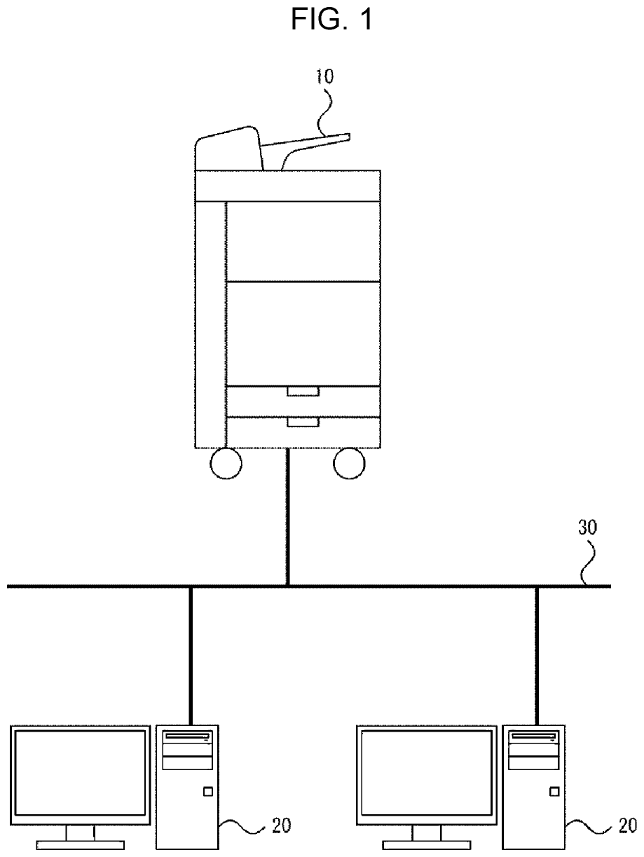

Hereinafter, an exemplary embodiment for implementing the technology of the present disclosure will be described in detail with reference to the drawings. FIG. 1 is a diagram illustrating a system configuration of an image reading system according to an exemplary embodiment.

As illustrated in FIG. 1, an image reading system according to the present exemplary embodiment includes an image forming apparatus 10 and a terminal device 20.

The image forming apparatus 10 is what is called a multifunction peripheral that has multiple functions such as copying, printing, faxing, and scanning functions. The image forming apparatus 10 is an example of an information processing system according to the technology of the present disclosure.

The terminal device 20 is connected to the image forming apparatus 10 via a network 30. The terminal device 20 is a terminal for operating the image forming apparatus 10. The terminal device 20 generates print data and transmits the print data to the image forming apparatus 10. Furthermore, the terminal device 20 acquires and stores a document file of a document read by the image forming apparatus 10. The terminal device 20 is implemented by, for example, a computer.

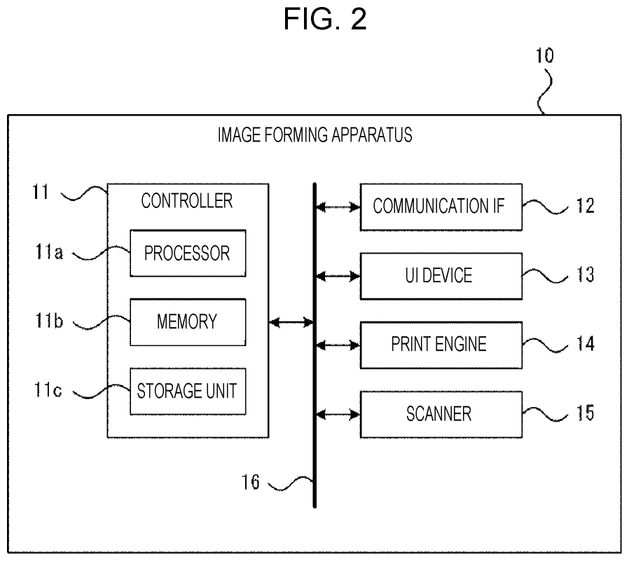

Next, a hardware configuration of the image forming apparatus 10 according to the present exemplary embodiment will be described. FIG. 2 is a block diagram illustrating the hardware configuration of the image forming apparatus 10.

As illustrated in FIG. 2, the image forming apparatus 10 includes a controller 11, a communication interface (abbreviated as communication IF) 12, a user interface device (abbreviated as UI device) 13, a print engine 14, and a scanner 15. These components are connected to one another via a control bus 16.

The controller 11 includes a processor 11a, a memory 11b, and a storage unit 11c. The processor 11a executes predetermined processing based on a program that is read from the storage unit 11c and loaded to the memory 11b. The storage unit 11c includes, for example, a ROM, an HDD, or an SSD. The storage unit 11c stores various programs, data, etc.

In the description according to the present exemplary embodiment, the processor 11a reads and executes a program stored in the storage unit 11c, but this is not a limitation. The program may be provided in a form of being recorded in a computer-readable recording medium as described above. Further, the program may be acquired from an external device via a communication line.

The communication IF 12 performs data transmission and reception with an external device or the like. The UI device 13 is a device for a user to receive or input information, such as a touch panel and/or a button. The print engine 14 prints an image on a recording medium such as a print sheet through steps such as charging, exposure, development, transfer, and fixing. The scanner 15 reads a document loaded in the image forming apparatus 10 and outputs the read document as image data in a set image format. The scanner 15 is an example of a reading device in the technology of the present disclosure.

In the image reading system, a document file of a document read by the image forming apparatus 10 is normally stored in a designated folder that is designated by a user. However, it is desired to automatically determine a storage folder, in which a document file of a document read by the image forming apparatus 10 is stored, from among a plurality of folders with any folder names and store the document file in the storage folder.

The image forming apparatus 10 according to the present exemplary embodiment is designed to meet such demands, and the controller 11 acquires information of a folder structure in a designated folder that is designated by a user, acquires a document file of a document read by the scanner 15 and information of a character recognition result for the document file, and when a folder that matches a character string included in the character recognition result for the document file is present among names of folders in a first layer of the designated folder, determines that the matching folder is a storage folder of the document file, determines a storage folder of the document file by the same processing as the first layer in layers from a second layer to a lowermost layer of the designated folder, determines a storage path indicating a storage destination of the document file, and stores the document file in the storage destination indicated by the determined storage path.

Here, the “information of the folder structure in the designated folder” is information including the name of each folder in the designated folder and the hierarchical structure of the folder.

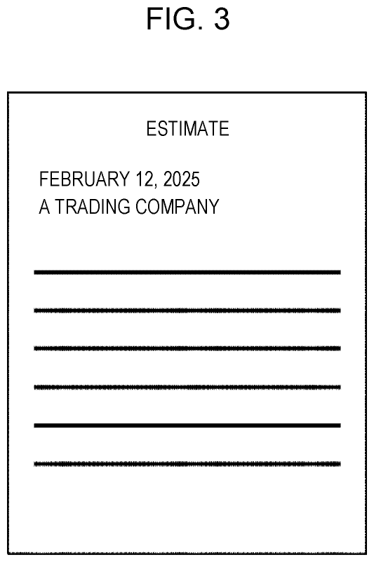

Hereinafter, the specific processing will be described. Here, as an example, the case where the image forming apparatus 10 reads the document illustrated in FIG. 3 will be described.

The document is an estimate for A trading company and, as a result of character recognition for the document file, the character information of “A trading company” and “Estimate” is extracted.

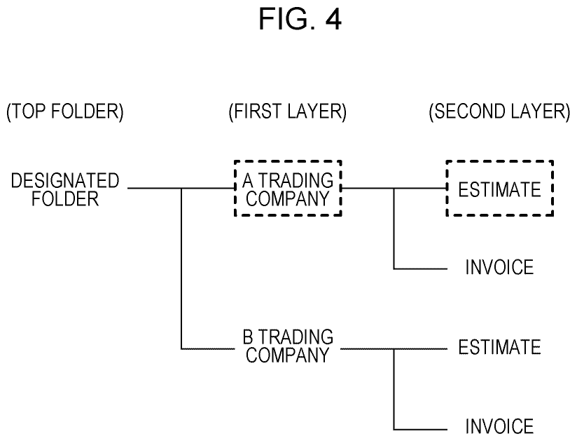

In addition, as illustrated in FIG. 4, it is assumed that the folders with the names “A trading company” and “B trading company” are present in a first layer of the designated folder that is designated by the user, and the folders with the names “Estimate” and “Invoice” are present in a second layer of each folder of the first layer.

In this case, the controller 11 acquires the information of the folder structure in the designated folder that is designated by the user as illustrated in FIG. 4. Further, the controller 11 acquires the document file of the document read by the scanner 15 and the character recognition result including the character information of “A trading company” and “Estimate” as the information of the character recognition result for the document file.

Subsequently, since the folder “A trading company” that matches the character string included in the character recognition result for the document file is present among the names of the folders in the first layer of the designated folder, the controller 11 determines that the folder “A trading company” is the storage folder of the document file.

In addition, since the folder “Estimate” that matches the character string included in the character recognition result for the document file is present among the names of the folders in the second layer of the folder “A trading company”, the controller 11 determines that the folder “Estimate” is the storage folder of the document file.

In this example, since the folders are provided only up to the second layer in the designated folder, the controller 11 determines that the storage path is “designated folder\A trading company\estimate” and stores the document file in the storage destination indicated by the determined storage path.

According to the present exemplary embodiment, the controller 11 may display the storage path of the storage destination of the document file when storing the document file, receive an instruction input to store the document file in the displayed storage destination, and store the document file in the storage destination indicated by the storage path when receiving an instruction input to store the document file from the user.

Further, when a folder that matches a character string included in the character recognition result for the document file is not present among the names of the folders in the respective layers of the designated folder, the controller 11 may create a new folder and determine that the newly created folder is the storage folder of the document file.

In this case, in each layer of the new folder, when a folder that matches a character string included in the character recognition result for the document file is present among the names of the folders in the same layer outside the new folder, the controller 11 may create a new folder with the same name as the matching folder and determine that the newly created folder is the storage folder of the document file.

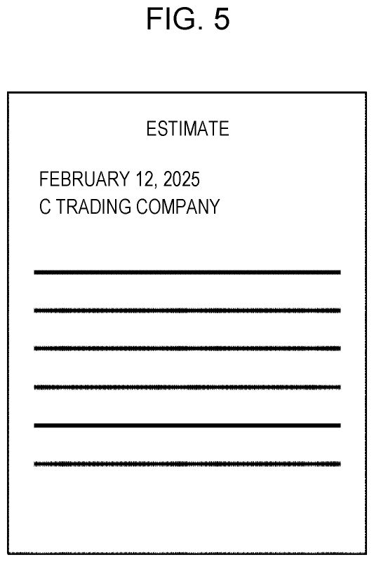

The specific processing will be described below. Here, as an example, the case where a document as illustrated in FIG. 5 is read in the image forming apparatus 10 will be described.

The document is an estimate for C Trading Company and, as a result of character recognition for the document file, the character information of “C trading company” and “Estimate” is extracted.

The structure of the designated folder, which is designated by the user, is the structure illustrated in FIG. 4 as described above.

In this case, the controller 11 acquires the information of the folder structure in the designated folder that is designated by the user as illustrated in FIG. 4. Further, the controller 11 acquires the document file of the document read by the scanner 15 and the character recognition result including the character information of “C trading company” and “Estimate” as the information of the character recognition result for the document file.

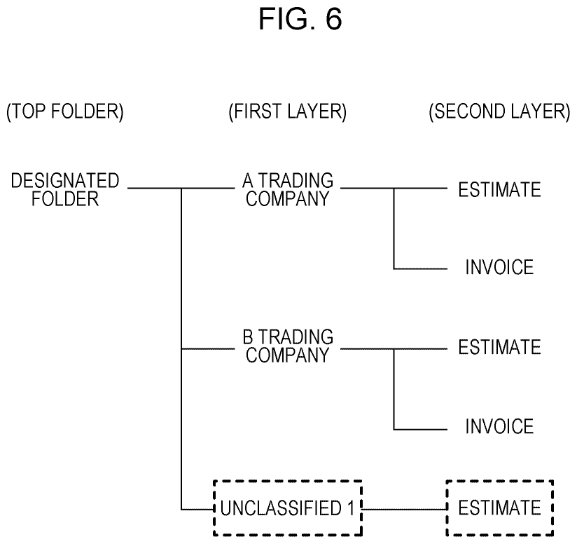

Subsequently, since a folder that matches a character string included in the character recognition result for the document file is not present among the names of the folders in the first layer of the designated folder, the controller 11 newly creates a folder with the name “Unclassified 1” as illustrated in FIG. 6 and determines that the folder “Unclassified 1” is the storage folder of the document file.

In addition, since a folder that matches the character string “Estimate” included in the character recognition result for the document file is present among the names of the folders in the second layer outside the newly created folder “Unclassified 1”, the controller 11 newly creates a folder with the name “Estimate” in the newly created folder “Unclassified 1” and determines that the folder “Estimate” is the storage folder of the document file.

In this example, since the folders are provided only up to the second layer in the designated folder, the controller 11 determines that the storage path is “designated folder\unclassified 1\estimate” and stores the document file in the storage destination indicated by the determined storage path.

When a plurality of folders that matches a character string included in the character recognition result for the document file is present in each layer of the designated folder, the controller 11 may determine that the folder with the highest priority among the previously set priorities of the respective folders is the storage folder of the document file.

In this case, the controller 11 may set a higher priority for a folder having a larger number of document files stored in the past for each layer of the designated folder.

When a plurality of folders that matches a character string included in the character recognition result for the document file is present in each layer of the designated folder, the controller 11 may create a new folder and determine that the newly created folder is the storage folder of the document file.

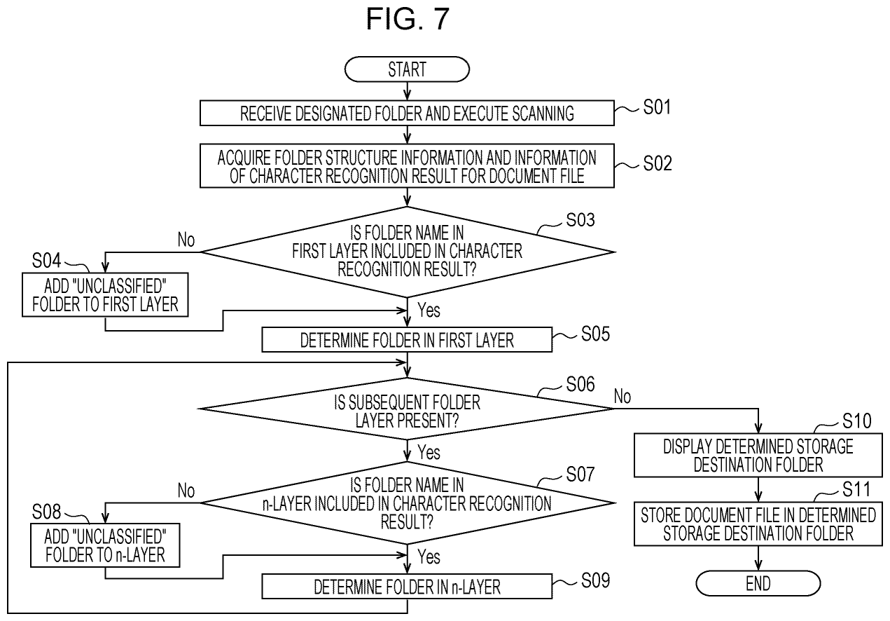

An example of a flow of processing to determine the storage folder in which the document file of the document read by the scanner 15 is stored in the image forming apparatus 10 according to the present exemplary embodiment will be described below in detail with reference to the flowchart of FIG. 7.

As illustrated in FIG. 7, first, in step S01, the controller 11 receives a designated folder from the user and executes scanning.

Subsequently, in step S02, the controller 11 acquires the information of the folder structure in the designated folder and the information of the character recognition result for the document file acquired by scanning.

Subsequently, in step S03, the controller 11 determines whether the folder name in the first layer is included in the character recognition result.

When it is determined in step S03 that the folder name in the first layer is included in the character recognition result, in step S05, the controller 11 determines that the folder with the name that matches the character recognition result in the first layer is the folder of the storage destination.

When it is determined in step S03 that the folder name in the first layer is not included in the character recognition result, in step S04, the controller 11 adds a folder with the name “Unclassified” to the first layer in the designated folder, and in step S05, determines that the added folder is the folder of the storage destination.

Subsequently, in step S06, the controller 11 determines whether the subsequent folder layer is present.

When it is determined in step S06 that the subsequent folder layer is present, in step S07, the controller 11 determines whether the folder name in the second layer is included in the character recognition result.

When it is determined in step S07 that the folder name in the second layer is included in the character recognition result, in step S09, the controller 11 determines that the folder with the name that matches the character recognition result in the second layer is the folder of the storage destination, and the processing proceeds to step S06.

When it is determined in step S07 that the folder name in the second layer is not included in the character recognition result, in step S08, the controller 11 adds the folder with the name “Unclassified” to the second layer in the designated folder and, in step S09, determines that the added folder is the folder of the storage destination, and the processing proceeds to step S06.

Then, the processing from step S06 to step S09 is repeated until there is no more subsequent folder layer.

When it is determined in step S06 that the subsequent folder layer is not present, in step S10, the controller 11 displays the determined storage destination folder on a user interface such as a touch panel.

Subsequently, in step S11, the controller 11 stores the document file in the determined storage destination folder in response to an instruction from the user, and ends the processing.

### Modification

The image reading system according to the exemplary embodiment of the present disclosure has been described above, but the technology of the present disclosure is not limited to the above-described exemplary embodiment and can be appropriately modified.

For example, in the above-described exemplary embodiment, the image forming apparatus 10 reads a document and determines the storage destination folder of the document file. That is, the image forming apparatus 10 has both functions of the information processing system and the reading device according to the technology of the present disclosure.

However, the present disclosure is not limited to such an aspect, and the image forming apparatus may read a document, and an application outside the image forming apparatus may determine the storage destination folder of the document file. That is, the image forming apparatus may have the function of the reading device according to the technology of the present disclosure, and the external application may have the function of the information processing system according to the technology of the present disclosure.

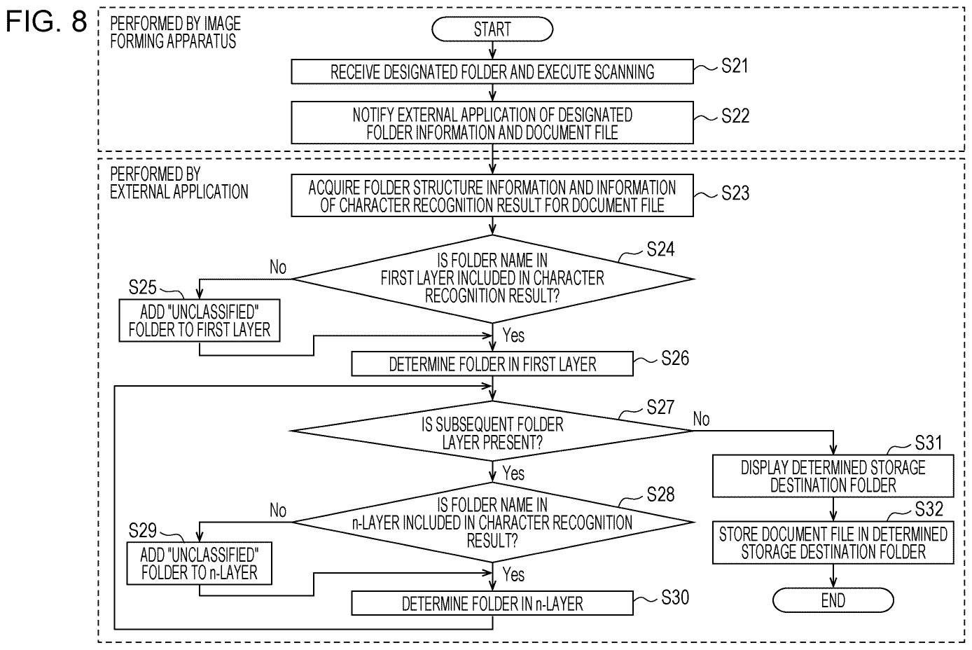

To be more specific, as illustrated in FIG. 8, first, in step S21, the image forming apparatus receives a designated folder from the user and executes scanning.

Subsequently, in step S22, the image forming apparatus notifies the external application of the designated folder information and the document file.

In step S23, the external application acquires, from the image forming apparatus, the information of the folder structure in the designated folder and the information of the character recognition result for the document file acquired by scanning.

The processing after step S23 is the same as the processing from step S02 to step S11 in the flowchart of FIG. 7, and thus the description thereof will be omitted.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the technology according to the present disclosure, the system includes both a system configured by a plurality of apparatuses and a system configured by a single apparatus.

The technology of the present disclosure can also be applied to a program and a program product.

### Appendix

(((1)))

An information processing system comprising:
a processor configured to:
   acquire information of a folder structure in a designated folder that is designated by a user;
   acquire a document file of a document read by a reading device and information of a character recognition result for the document file;
   when a folder that matches a character string included in the character recognition result for the document file is present among names of folders in a first layer of the designated folder, determine that the matching folder is a storage folder of the document file;
   determine a storage folder of the document file by the same processing as the first layer in layers from a second layer to a lowermost layer of the designated folder and determine a storage path indicating a storage destination of the document file; and
   store the document file in the storage destination indicated by the determined storage path.
(((2)))

The information processing system according to (((1))), wherein the processor is configured to, when storing the document file, display the storage path of the storage destination of the document file and receive an instruction input to store the document file in the displayed storage destination.
(((3)))

The information processing system according to (((1))) or (((2))), wherein the processor is configured to, when a folder that matches the character string included in the character recognition result for the document file is not present among names of folders in respective layers of the designated folder, create a new folder and determine that the newly created folder is the storage folder of the document file.
(((4)))

The information processing system according to (((3))), wherein the processor is configured to, in each layer of the new folder, when a folder that matches the character string included in the character recognition result for the document file is present among names of folders in the same layer outside the new folder, create a new folder with the same name as the matching folder and determine that the newly created folder is the storage folder of the document file.
(((5)))

The information processing system according to any one of (((1))) to (((4))), wherein the processor is configured to, when a plurality of folders that matches the character string included in the character recognition result for the document file is present in each layer of the designated folder, determine that a folder with a highest priority among previously set priorities of respective folders is the storage folder of the document file.
(((6)))

The information processing system according to (((5))), wherein the processor is configured to set a higher priority for a folder having a larger number of document files stored in the past for each layer of the designated folder.
(((7)))

The information processing system according to any one of (((1))) to (((4))), wherein the processor is configured to, when a plurality of folders that matches the character string included in the character recognition result for the document file is present in each layer of the designated folder, create a new folder and determine that the newly created folder is the storage folder of the document file.
(((8)))

A program causing a computer to execute a process comprising:
acquiring information of a folder structure in a designated folder that is designated by a user;
acquiring a document file of a document read by a reading device and information of a character recognition result for the document file;
when a folder that matches a character string included in the character recognition result for the document file is present among names of folders in a first layer of the designated folder, determining that the matching folder is a storage folder of the document file;
determining a storage folder of the document file by the same processing as the first layer in layers from a second layer to a lowermost layer of the designated folder and
determining a storage path indicating a storage destination of the document file; and storing the document file in the storage destination indicated by the determined storage path.

What is claimed is:

1. An information processing system comprising:
a processor configured to:
acquire information of a folder structure in a designated folder that is designated by a user;
acquire a document file of a document read by a reading device and information of a character recognition result for the document file;
when a folder that matches a character string included in the character recognition result for the document file is present among names of folders in a first layer of the designated folder, determine that the matching folder is a storage folder of the document file;
determine a storage folder of the document file by the same processing as the first layer in layers from a second layer to a lowermost layer of the designated folder and determine a storage path indicating a storage destination of the document file; and
store the document file in the storage destination indicated by the determined storage path.

2. The information processing system according to claim 1, wherein the processor is configured to, when storing the document file, display the storage path of the storage destination of the document file and receive an instruction input to store the document file in the displayed storage destination.

3. The information processing system according to claim 1, wherein the processor is configured to, when a folder that matches the character string included in the character recognition result for the document file is not present among names of folders in respective layers of the designated folder, create a new folder and determine that the newly created folder is the storage folder of the document file.

4. The information processing system according to claim 3, wherein the processor is configured to, in each layer of the new folder, when a folder that matches the character string included in the character recognition result for the document file is present among names of folders in the same layer outside the new folder, create a new folder with the same name as the matching folder and determine that the newly created folder is the storage folder of the document file.

5. The information processing system according to claim 1, wherein the processor is configured to, when a plurality of folders that matches the character string included in the character recognition result for the document file is present in each layer of the designated folder, determine that a folder with a highest priority among previously set priorities of respective folders is the storage folder of the document file.

6. The information processing system according to claim 5, wherein the processor is configured to set a higher priority for a folder having a larger number of document files stored in the past for each layer of the designated folder.

7. The information processing system according to claim 1, wherein the processor is configured to, when a plurality of folders that matches the character string included in the character recognition result for the document file is present in each layer of the designated folder, create a new folder and determine that the newly created folder is the storage folder of the document file.

8. A non-transitory computer readable medium storing a program causing a computer to execute a process comprising:
acquiring information of a folder structure in a designated folder that is designated by a user;
acquiring a document file of a document read by a reading device and information of a character recognition result for the document file;
when a folder that matches a character string included in the character recognition result for the document file is present among names of folders in a first layer of the designated folder, determining that the matching folder is a storage folder of the document file;
determining a storage folder of the document file by the same processing as the first layer in layers from a second layer to a lowermost layer of the designated folder and determining a storage path indicating a storage destination of the document file; and
storing the document file in the storage destination indicated by the determined storage path.
